(19) United States
(12) Patent Application Publication
(10) Pub. No.: US 2023/0088744 A1
(43) Pub. Date: Mar. 23, 2023

(54) Autoclave Reactor System Comprising an Agitator with Polycrystalline Diamond Bearings

(71) Applicant: ExxonMobil Chemical Patents Inc., Baytown, TX (US)

(72) Inventors: Antonio R. MARQUEZ, Baton Rouge, LA (US); Michael W. JACKMAN, Zachary, LA (US); Eric R. LEWIS, Baton Rouge, LA (US)

(21) Appl. No.: 17/759,405

(22) PCT Filed: Jan. 7, 2021
(86) PCT No.: PCT/US2021/012477

§ 371 Date: Jul. 25, 2022

Related U.S. Application Data
(60) Provisional application No. 62/967,769, filed on Jan. 30, 2020.

(51) Int. Cl. B01J 19/18; B01J 19/00; B01J 3/04

(52) U.S. Cl. CPC B01J 19/18; B01J 19/0066; B01J 3/04; B01J 2219/00274; B01J 2219/00306; B01J 2219/00322; B01J 2219/00479; B01J 2219/00481; B01J 2219/00601; B01J 2219/0072; B01J 2219/00736; B01J 2219/00763; B01J 2219/00779; B01J 2219/02; B01J 2219/0231; B01J 2219/1943

(57) ABSTRACT

An autoclave reactor having polycrystalline diamond bearings. The autoclave reactor can include a housing for containing at least one reaction material therein, a motor disposed within the housing, an agitator connected to the motor for stirring the at least one material within the housing, the agitator having a shaft connected to the motor at one end thereof, and at least one bearing disposed adjacent to the shaft or adjacent to the connection of the shaft to the motor, the at least one bearing being made of polycrystalline diamond. A process for making low density polyethylene (LDPE) can include introducing ethylene to the autoclave reactor disclosed herein and polymerizing the ethylene within a housing of the reactor to provide the low density polyethylene.

### CROSS-REFERENCE TO RELATED APPLICATION

This application claims the benefit of U.S. Provisional Application 62/967,769, filed Jan. 30, 2020 entitled “Autoclave Reactor System Comprising an Agitator with Polycrystalline Diamond Bearings”, the entirety of which is incorporated by reference herein.

### FIELD

Embodiments disclosed herein generally relate to autoclave reactors. More particularly, such embodiments relate to an autoclave reactor system comprising an agitator with polycrystalline diamond bearings.

### BACKGROUND

Autoclave reactors are commonly used in the production of low density polyethylene (LDPE) at relatively high temperatures and pressures. The LDPE produced by autoclave reactors can be used in a variety of products and applications such as film, paper coating, injection molding, and wire/cable insulation.

Autoclave reactors typically include an internal agitator for stirring the material disposed within the reactor vessel. The agitator is usually equipped with a shaft assembly having paddles extending from a shaft and a high efficiency motor for rotating the shaft. Metallic anti-friction bearings are positioned at the base of the agitator and in the motor of the agitator.

The reliability of the agitator is affected by the harsh reaction conditions within the autoclave reactor, specifically the high temperatures and pressures required for the production of LDPE at commercially desirable flowrates. The reliability of the agitator is also affected by whether the anti-friction bearings are functioning properly. As the bearings at the base of the agitator begin to fail, the reliability of the bearings in the motor decreases significantly. As a result, vibrations are generated that adversely affect the components of the agitator.

Furthermore, the longevity of the bearings is limited by friction due to the low lubrication environment to which the bearings are subjected. Any downtime for lubricating the bearings is undesirable. There is a need, therefore, for autoclave reactors having an agitator with bearings that have less degradation due to harsh conditions and friction. Bearings having longer lifetimes than those traditionally used in autoclave reactors is also highly desired.

### SUMMARY

An autoclave reactor having polycrystalline diamond bearings is provided. In one or more embodiments, an autoclave reactor can include a housing for containing at least one reaction material therein, a motor disposed within the housing, an agitator connected to the motor for stirring the at least one material within the housing, the agitator having a shaft connected to the motor at one end thereof, and at least one bearing disposed adjacent to the shaft or adjacent to the connection of the shaft to the motor, the at least one bearing being made of polycrystalline diamond.

In one or more embodiments, a process for making low density polyethylene (LDPE), can include: introducing ethylene to an autoclave reactor, the autoclave reactor having a housing for containing at least one reaction material therein, a motor disposed within the housing, an agitator connected to the motor for stirring the at least one material within the housing, the agitator comprising a shaft connected to the motor at one end thereof, and at least one bearing disposed adjacent to the shaft or adjacent to the connection of the shaft to the motor, the at least one bearing being made of polycrystalline diamond; and polymerizing the ethylene within the housing to provide the low density polyethylene.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a cross-sectional view of an illustrative autoclave reactor having an agitator with polycrystalline diamond bearings, according to one or more embodiments described herein.

FIG. 2 depicts a detailed view of a portion of the agitator from FIG. 1, according to one more embodiments described herein.

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

Furthermore, in the following discussion and in the claims, the terms “including” and “comprising” are used in an open-ended fashion, and thus should be interpreted to mean “including, but not limited to.”

The term “or” is intended to encompass both exclusive and inclusive cases, i.e., “A or B” is intended to be synonymous with “at least one of A and B,” unless otherwise expressly specified herein.

As used herein, the indefinite article “a” or “an” shall mean “at least one” unless specified to the contrary or the context clearly indicates otherwise. Thus, embodiments using “a bearing” include embodiments where one, two, or more bearings are used, unless specified to the contrary or the context clearly indicates that only one bearing is used.

The term “autoclave reactor” refers to any container for chemical reactions capable of withstanding high temperatures and pressures.

The term “bearing” refers to a machine element that reduces friction between two or more parts.

The term “paddle” refers to a rod having a broad blade at the end of the rod.

A “polymer” has two or more of the same or different repeating units/mer units or units. A “homopolymer” is a polymer having units that are the same. A “copolymer” is a polymer having two or more units that are different from each other. A “terpolymer” is a polymer having three units that are different from each other. The term “different” as used to refer to units indicates that the units differ from each other by at least one atom or are different isomerically. The definition of copolymer, as used herein, includes terpolymers and the like. Likewise, the definition of polymer, as used herein, includes homopolymers, copolymers, and the like.

### System

An improved autoclave reactor system is provided. It has been discovered that using polycrystalline diamond (PCD) bearings at an end of an agitator shaft can significantly improve the reliability of the bearings. In particular, the PCD bearings provide for low friction coefficients between the moving components of the agitator, thereby reducing degradation of the bearings and reducing undesirable vibrations caused by such degradation. As such, the life of the bearings can be extended, which allows for the continuous operation of the reactor system in a low lubricity environment.

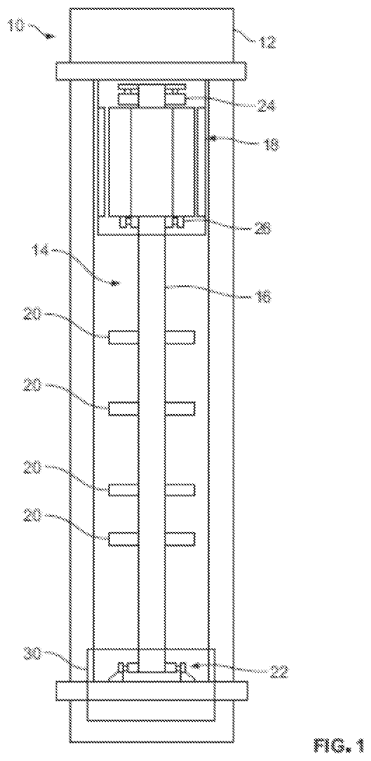

FIG. 1 depicts a cross-sectional view of an illustrative autoclave reactor system 10 having an agitator 14 with polycrystalline diamond (“PCD”) bearings 22, 24, 26, according to one or more embodiments. The autoclave reactor system 10 can also include a housing 12 for containing reaction materials, such as the monomer, diluent, and initiator. The agitator 14 can be disposed within the housing 12 for agitating or stirring the reaction materials. The agitator 14 can include a shaft 16 and a motor 18 for rotating the shaft 16. Any suitable motor 18, whether known in the art now or to be developed in the future, can be used. The autoclave reactor system 10 can also include one or more paddles 20 that outwardly extend from the shaft 16 to provide additional surface area for moving, mixing, and agitating the material within the housing 12.

As depicted in FIG. 1, one or more bearings (two are shown, i.e. bearings 24, 26) can be located within the motor 18 where the shaft 16 is connected to the motor 18. In addition, one or more bearings (one is shown, i.e., bearing 22) can be disposed adjacent to the base of the shaft 16. It should be recognized by one of ordinary skill in the art that any suitable number of bearings can be used and that they could be disposed anywhere along the shaft 16. The bearings 22, 24, 26 can be made of or can include polycrystalline diamond. The term “polycrystalline diamond” refers to a material having inter-bonded diamond grains and interstices between the diamond grains. Suitable PCD material can be made by subjecting an aggregated mass of diamond grains to a high pressure and temperature in the presence of a sintering aid for promoting the inter-bonding of diamond grains. The sintering aid is typically a metal such as cobalt, nickel, iron, or an alloy including one or more such metals. The sintering aid can also be referred to as a catalyst material for diamond and a binder material. Interstices within the sintered PCD material can be wholly or partially filled with residual catalyst material.

In certain embodiments, the PCD bearings 22, 24, 26 can include at least 90 wt %, at least 95 wt %, or at least 99 wt % polycrystalline diamond, based on the total weight of the bearing. Preferably, each bearing 22, 24, 26 is made from one or more PCD materials. However, any one or more of the bearings 22, 24, 26 could be made from other materials, including one or more metals or metal alloys, such as steel.

The shape of each bearing 22, 24, 26 can vary depending on the type of bearing considered suitable by one of ordinary skill in the art. For example, the bearings can be plain bearings, ball bearings, cylindrical roller bearings, taper roller bearings, and spherical roller bearings. The bearings 22, 24, 26 can be of the same type or each bearing 22, 24, 26 can be different from the others.

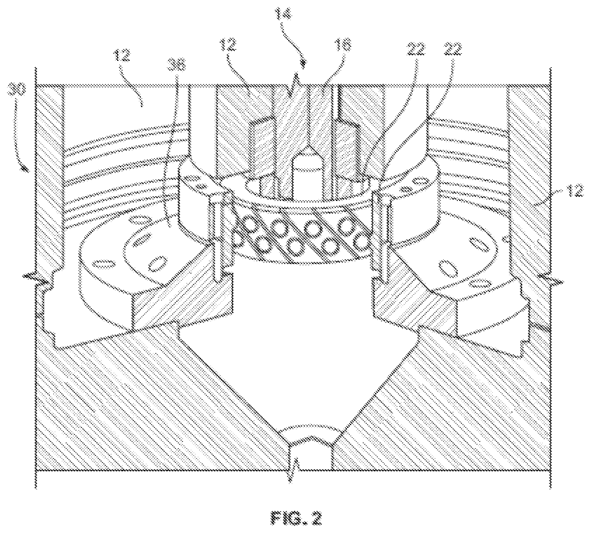

FIG. 2 depicts a detailed view of a portion 30 of FIG. 1. As depicted in FIG. 2, the bearing 22 can be disposed adjacent to the shaft 16 of the agitator 14 and an inner wall of the housing 12. The agitator 14 can further include a holder 36 adjacent to the bearing 22 for securing the bearing 22 to the shaft 16.

### Process

The autoclave reactor system 10 can be used to produce low density polyethylene (LDPE). As such, the material introduced to the reactor can be ethylene. The autoclave reactor system 10 can also be used to produce LDPE copolymers, which can be or can include one or more copolymers, including terpolymers, having ethylene-derived monomer units and at least one other olefin-derived monomer units. The materials introduced to the reactor system 10 thus can include ethylene and at least one other comonomer.

Examples of suitable comonomers include α-olefins such as C₃-C₂₀ α-olefins or C₃-C₁₂ α-olefins. The α-olefin comonomer can be linear or branched, and two or more comonomers can be used, if desired. Examples of suitable comonomers include linear C₃-C₁₂ α-olefins and α-olefins having one or more C₁-C₃ alkyl branches or an aryl group. Specific examples include but are not limited to propylene; 1-butene; 3-methyl-1-butene; 3,3-dimethyl-1-butene; 1-pentene; 1-pentene with one or more methyl, ethyl, or propyl substituents; 1-hexene with one or more methyl, ethyl, or propyl substituents; 1-heptene with one or more methyl, ethyl, or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene.

The LDPE polymer or copolymer can be produced using a high pressure and high temperature polymerization process. Various process variations that achieve safe and economical operating conditions are known in the art. By way of example, the polymerization process can be performed at a pressure of about 1,310 to about 3,100 bar and a temperature of about 148° C. to about 260° C. when a single autoclave reactor is used.

The polymerization reaction can be enhanced or initiated by the injection of at least one initiator or solvent. Suitable initiators can be or can include one or more organic peroxides, such as t-butylperoxy neodecanoate together with t-butylperoxy 2-ethylhexanoate, t-butylperoxy perbenzoate, or di(t-butyl)peroxide. Suitable solvents can be or can include one or more linear or branched C₄ to C₇ alkanes. Particularly preferred solvents include butane, pentane, hexane, iso-butane, iso-pentane, iso-hexane, or mixtures thereof.

The LDPE polymer or copolymer process can take place in a single autoclave reactor, a multi-chamber autoclave reactor, or a cascade of autoclave reactors arranged in parallel or series, depending on the desirable product slate. The autoclave reactor(s) can include a thick-walled forged or two-layer shrunk cylindrical housing. The ratio of inside length to inner diameter can range from about one to about two. The autoclave reactors) can be equipped with an agitator driven by an external or internal electric motor, with an internal motor being preferred. The agitator desirably provides good mixing of the ethylene, the initiator, if any, and the comonomer. Preferably, the agitator achieves high turbulence near the inside wall to avoid polymer deposition.

The residence time in a single autoclave reactor 10 can range from about 15 to about 60 seconds. The reactor can be operated adiabatically such that the heat of reaction is removed by the fresh ethylene entering the reactor. The conversion rate is related, therefore, to the difference in temperature between the feed and the reactor temperature. The main feature of the LDPE polymer or copolymer produced from a single autoclave process is a broader molecular-weight distribution, which gives excellent properties for shrink-films and heavy duty packaging.

The LDPE polymer or copolymer process can be improved when autoclave reactors 10 are arranged in series. By feeding fresh ethylene into the line between the reactors and/or removing heat by means of coolers, the conversion rate can be increased. When initiators of different activity are used in the different reactors, the reactors can be run at different temperatures. Also, the split of the feed of fresh ethylene can be varied. Compared to the single reactor process, the cascade arrangement gives more flexibility to adjust the properties of LDPE polymer or copolymer.

Higher conversion rates can be achieved in a multi-zone or autoclave reactor. The multi-zone reactor can include an elongated cylindrical housing having a ratio of length to inner diameter of about 10 to about 12. The reactor can be subdivided by baffles, and the agitator can extend through two or more chambers, e.g., two to five chambers. The chambers can have different volumes, with the top chamber being the largest. For example, the top chamber can make up 30% to 50% of the total volume. Each chamber can be equipped with thermocouples and feed lines for fresh ethylene, comonomer, if any, and initiator, if any.

The multi-zone autoclave reactor can be run with a temperature profile. The temperature in the top chamber can be moderately high, e.g., in the range of about 165° C. to about 200° C. The temperature in the bottom zone can be even higher, e.g., in the range of about 280° C. to about 290° C., to adjust the density of the polymer. Through the temperature profile, which is controlled by the initiator feed and the split of fresh ethylene, the properties of the polymers can be varied. Different peroxides can be used as initiators when the zones are run at different temperatures.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. An autoclave reactor, comprising:
a housing for containing at least one reaction material therein;
a motor disposed within the housing;
an agitator connected to the motor for stirring the at least one material within the housing, the agitator comprising a shaft connected to the motor at one end thereof; and
at least one bearing disposed adjacent to the shaft or adjacent to the connection of the shaft to the motor, the at least one bearing being made of polycrystalline diamond.

2. The autoclave reactor of claim 1, wherein the at least one bearing is disposed adjacent to a base of the shaft.

3. The autoclave reactor of claim 1, wherein the agitator further comprises a holder disposed adjacent to the at least one bearing for securing the at least one bearing to the shaft.

4. The autoclave reactor of claim 1, wherein the motor is disposed adjacent to a top of the shaft for rotating the shaft.

5. The autoclave reactor of claim 1, wherein the agitator further comprises at least one paddle extending from the shaft.

6. An autoclave reactor system, comprising:
an outer housing for holding at least one material introduced to the reactor system; and
an agitator disposed within the outer housing for agitating the at least one material, comprising:
a shaft capable of being rotated; and
a motor disposed adjacent to an end of the shaft for rotating the shaft, wherein the motor comprises a first bearing comprising polycrystalline diamond.

7. The autoclave reactor system of claim 6, wherein the agitator further comprises a second bearing disposed adjacent to another end of the shaft that is opposite to the end of the shaft, wherein the second bearing comprises polycrystalline diamond.

8. The autoclave reactor system of claim 7, wherein (a) the end is a top of the shaft; and/or (b) said other end is a base of the shaft.

9. The autoclave reactor system of claim 7, wherein the agitator further comprises a holder disposed adjacent to the second beating for securing the second bearing to the shaft.

10. The autoclave reactor system of claim 6, wherein the agitator further comprises at least one paddle extending from the shaft.

11. A process for making low density polyethylene (LDPE), comprising:
introducing ethylene to an autoclave reactor, the autoclave reactor comprising:
a housing for containing at least one reaction material therein;
a motor disposed within the housing;
an agitator connected to the motor for stirring the at least one material within the housing, the agitator comprising a shaft connected to the motor at one end thereof; and
at least one bearing disposed adjacent to the shaft or adjacent to the connection of the shaft to the motor, the at least one bearing being made of polycrystalline diamond; and
polymerizing the ethylene within the housing to provide the low density polyethylene.

12. The process of claim 11, wherein the at least one bearing is disposed adjacent to a base of the shaft.

13. The process of claim 11, wherein the agitator further comprises a holder disposed adjacent to the at least one bearing for securing the at least one bearing to the shaft.

14. The process of claim 11, wherein the motor is disposed adjacent to a top of the shaft for rotating the shaft.

15. The process of claim 11, wherein the agitator further comprises at least one paddle extending from the shaft.

16. The process of claim 11, wherein the ethylene is polymerized at one or both of the following conditions: (a) a pressure of about 1,310 bar to about 3,100 bar; and (b) a temperature of about 148° C. to about 260° C.

17. The process of claim 11, further comprising introducing (i) at least one comonomer and/or (ii) an organic peroxide to the autoclave reactor.

18. The process of claim 11, further comprising introducing a product stream from the autoclave reactor to another autoclave reactor comprising another agitator having another shaft and another bearing comprising polycrystalline diamond disposed adjacent to the shaft.
